(19) United States
(12) Patent Application Publication
(10) Pub. No.: US 2010/0038218 A1
(43) Pub. Date: Feb. 18, 2010

(54) SWITCHABLE ELECTRICAL POWER OUTLET ADAPTER AND ASSOCIATED METHODS

(75) Inventors: Robert Johnson Fisher, Tucker, GA (US); Jeffrey McManamy Fisher, Atlanta, GA (US); James Forest Fisher, Atlanta, GA (US)

Correspondence Address: GEORGE R. REARDON, 3356 STATION COURT, LAWRENCVILLE, GA, 30044, US

(73) Assignee: F3 Group, LTD, Atlanta, GA (US)

(21) Appl. No.: 12/191,229

(22) Filed: Aug. 13, 2008

(51) Int. Cl. H01H 15/06; H01R 24/08

(52) U.S. Cl. 200/51.02; 200/550

(57) ABSTRACT

In various exemplary embodiments, the technology described herein provides for switchable electrical power at an electrical receptacle connected to a commercial power supply in order to eliminate idle power drain. A switchable electrical power outlet adapter is provided. A switchable electrical power outlet is provided. Each includes a receptacle socket configured for receipt of a plug of an electric appliance; a control circuit disposed within the housing, the control circuit configured to selectively terminate electrical connectivity between the electrical receptacle and the electrical appliance; and a switch disposed upon the housing and electrically connected to the control circuit, the switch having an ON state and an OFF state. The OFF state of the switch is visually represented on the housing of the switchable electrical power outlet adapter as GREEN to encourage greater use of the switchable electrical power outlet adapter and greater energy efficiency.

### FIELD OF THE INVENTION

The technology described herein relates generally to the field of electrical switching. More specifically, this technology relates to switchable electrical power outlet adapters to eliminate idle power drain.

### BACKGROUND OF THE INVENTION

Energy inefficiency occurs with idle power drain. Idle power drain is also known by other names such as: standby power, vampire power, phantom load, and leaking electricity. Each name simply refers to the electrical power consumed by electric appliances, for example, while they are switched in an “off” or “stand-by” mode. Power consumed by electric appliances that are not in operation, yet are plugged into a receptacle for power, is idle energy use and is considered wasted.

Electric appliances with idle power drain are numerous and can include, for example, coffee makers, hairdryers, power supplies, battery chargers, remote control receivers, computer devices, and power-consuming devices with no “off” switch. Idle power drain can be reduced by simply unplugging such devices when they are not in use. However, this task often remains undone. Idle power drain also can be reduced by utilizing energy efficient devices. This requires continual purchase and update of electric appliances. Idle power drain also can be reduced by discontinuing use of devices requiring battery chargers. However, this is often deemed an unpleasant alternative.

Related patents known in the art include the following. U.S. Pat. No. 3,440,347, issued to Spencer et al. on Feb. 2, 1969, discloses a remote control plug-in unit. U.S. Pat. No. 4,481,388, issued to Gillam et al. on Nov. 6, 1984, discloses an electrical plug with automatic shut-off feature. U.S. Pat. No. 5,990,769, issued to Tam on Nov. 23, 1999, discloses a switchable electric outlet adapter. U.S. Pat. No. 6,095,850, issued to Liu on Aug. 1, 2000, discloses an electric adapter with a display unit.

Other known references in the art include the following: a wireless lighting with a switch remote and wall receiver disclosed online at http://www.gethandyswitch.com, a centralized switch to control receptacles and thermostats disclosed online at http://www.greenswitch.tv, instructions for making a remote power switch disclosed online at http://www.instructables.com/id/make-your-own-remote-power-switches, and a method to enables users to power-cycle appliances not currently equipped with a power button disclosed online at http://www.pi-si.com/Switchboss.html and made by Peripheral Imaging Solutions, Inc.

The foregoing patent and other information reflect the state of the art of which the inventors are aware and are tendered with a view toward discharging the inventors' acknowledged duty of candor in disclosing information that may be pertinent to the patentability of the technology described herein. It is respectfully stipulated, however, that the foregoing patent and other information do not teach or render obvious, singly or when considered in combination, the inventors' claimed invention.

### BRIEF SUMMARY OF THE INVENTION

In various exemplary embodiments, the technology described herein provides for switchable electrical power at an electrical receptacle connected to a commercial power supply to eliminate idle power drain.

In one exemplary embodiment, the technology described herein provides a switchable electrical power outlet adapter for use between an electrical receptacle connected to a commercial power supply and an electric appliance in order to eliminate idle power drain. The switchable electrical power outlet adapter comprises: a housing; a plug disposed upon a rear of the housing, the plug configured for insertion into an electrical receptacle; a receptacle socket disposed upon the housing, the receptacle socket configured for receipt of a plug on an electric appliance; a control circuit disposed within the housing, the control circuit configured to selectively terminate electrical connectivity between the electrical receptacle and the electrical appliance; and a switch disposed upon the housing and electrically connected to the control circuit, the switch having an ON state and an OFF state. The OFF state of the switch is visually represented on the housing of the switchable electrical power outlet adapter as GREEN to encourage greater use of the switchable electrical power outlet adapter and greater energy efficiency.

The switchable electrical power outlet adapter provides electrical connectivity from a commercial power supply to the electrical receptacle, through the electrical power outlet adapter, and to the electric appliance only when the switch is in the ON state, thereby eliminating idle power drain when the switch is in the OFF state. Additionally, the switchable electrical power outlet adapter provides for the convertibility of an existing electrical receptacle into a switchable power outlet. The receptacle socket can comprise a duplex AC power socket and a quad AC power socket. The switch can comprise a single pull single throw (SPST) switch.

The switchable electrical power outlet adapter also includes a sensor disposed within the housing and electrically connected to the control circuit, the sensor configured to detect power usage of the electrical appliance and to ascertain that the electrical appliance is operating in one of a stand-by mode and a full-power mode. The sensor is remotely accessible such that activity of the switchable electrical power outlet adapter and attached electrical appliance is monitored remotely and wherein the control circuit can be influenced remotely to transition a switchable electrical power outlet adapter to an OFF state.

The switchable electrical power outlet adapter also includes an adapter address, the adapter address being a uniquely identifiable address specific to the switchable electrical power outlet adapter, wherein the switchable electrical power outlet adapter is remotely accessible based on the unique adapter address.

The switchable electrical power outlet adapter also includes a timer disposed within the housing and electrically connected to the control circuit, the timer configured to measure a predetermined time the electrical appliance is operating in a stand-by mode at which point the switchable electrical power outlet adapter will be turned to an OFF state.

In another exemplary embodiment, the technology described herein provides a method for eliminating idle power drain between an electrical receptacle connected to a commercial power supply and an electric appliance. The method comprises: utilizing a switchable electrical power outlet adapter comprising a housing; a plug disposed upon a rear of the housing; the plug configured for insertion into an electrical receptacle; a receptacle socket disposed upon the housing, the receptacle socket configured for receipt of a plug on an electric appliance; a control circuit disposed within the housing, the control circuit configured to selectively terminate electrical connectivity between the electrical receptacle and the electrical appliance; and a switch disposed upon the housing and electrically connected to the control circuit, the switch having an ON state and an OFF state; plugging the switchable electrical power outlet adapter into the electrical receptacle; plugging the electrical appliance into the receptacle socket disposed upon the housing of the switchable electrical power outlet adapter; and selectively alternating the switch to an OFF state to eliminate idle power drain when the electrical appliance is not needed for use.

The method also includes utilizing a switchable electrical power outlet adapter further comprising a sensor disposed within the housing and electrically connected to the control circuit, the sensor configured to detect power usage of the electrical appliance and to ascertain that the electrical appliance is operating in one of a stand-by mode and a full-power mode; detecting the power usage of the electrical appliance; ascertaining that the electrical appliance is operating in one of a stand-by mode and a full-power mode; and alternating the switch to an OFF state when it is ascertained that the electrical appliance has been operating in a stand-by mode for more than a predetermined amount of time.

The method also includes utilizing a switchable electrical power outlet adapter further comprising an adapter address, the adapter address being a uniquely identifiable address specific to the switchable electrical power outlet adapter, wherein the switchable electrical power outlet adapter is remotely accessible based on the unique adapter address; and remotely accessing the switchable electrical power outlet adapter based upon the unique adapter address.

The method also includes utilizing a switchable electrical power outlet adapter further comprising a timer disposed within the housing and electrically connected to the control circuit, the timer configured to measure a predetermined time the electrical appliance is operating in a stand-by mode at which point the switchable electrical power outlet adapter will be turned to an OFF state; setting the predetermined time; ascertaining the electrical appliance is operating in a stand-by mode for a time period greater than the predetermined time; and alternating the switch to an OFF state to eliminate idle power drain.

In yet another exemplary embodiment, the technology described herein provides a switchable electrical power outlet to eliminate idle power drain. The switchable electrical power outlet includes: an electrical receptacle housing; a receptacle socket disposed upon the electrical receptacle housing, the receptacle socket configured for receipt of a plug on an electric appliance; a control circuit disposed within the housing, the control circuit configured to selectively terminate electrical connectivity between the electrical receptacle and the electrical appliance; and a switch disposed upon the housing and electrically connected to the control circuit, the switch having an ON state and an OFF state. The switchable electrical power outlet provides electrical connectivity from a commercial power supply to the electric appliance only when the switch is in the ON state, thereby eliminating idle power drain when the switch is in the OFF state.

The switchable electrical power outlet includes: a sensor disposed within the electrical receptacle housing and electrically connected to the control circuit, the sensor configured to detect power usage of the electrical appliance and to ascertain that the electrical appliance is operating in one of a stand-by mode and a full-power mode.

The switchable electrical power outlet includes: an adapter address, the adapter address being a uniquely identifiable address specific to the switchable electrical power outlet, wherein the switchable electrical power outlet is remotely accessible based on the unique adapter address.

The switchable electrical power outlet includes: a timer disposed within the electrical receptacle housing and electrically connected to the control circuit, the timer configured to measure a predetermined time the electrical appliance is operating in a stand-by mode at which point the switchable electrical power outlet will be turned to an OFF state.

Advantageously, the technology described herein provides not only for switchable electrical power at an electrical receptacle connected to a commercial power supply to eliminate idle power drain, but also a technology that saves both money and energy. Consumers save money each month on their power utility bills due to lessened energy consumption. Additionally, the technology is environmentally supportive. Waste of energy, in the form of idle power drain, is eliminated. Thus, there are many advantages to the system and methods described herein.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a front view schematic diagram of a switchable electrical power outlet adapter, illustrating, in particular, the switch controlling both outlets, according to an embodiment of the technology;

FIG. 2 is a front view schematic diagram of a switchable electrical power outlet adapter, illustrating, in particular, the switch controlling only one of the two outlets, according to an embodiment of the technology;

FIG. 3 is a front view schematic diagram of a switchable electrical power outlet adapter, illustrating, in particular, dual switches, each switch controlling only one of the two outlets, according to an embodiment of the technology;

FIG. 4 is a front view schematic diagram of a switchable electrical power outlet adapter, illustrating, in particular, four switches and four outlets, each switch controlling only one of the four outlets, according to an embodiment of the technology;

FIG. 5 is a front view schematic diagram of a switchable electrical power outlet adapter;

FIG. 6 is a schematic diagram of the electrical circuit for a switchable electrical power outlet adapter, according to an embodiment of the technology;

FIG. 7 is a schematic diagram of a multiplicity of switchable electrical power outlet adapters in a centralized remote control configuration, according to an embodiment of the technology;

FIG. 8 is a front view schematic diagram of a switchable electrical power outlet adapter, illustrating, in particular, the switch controlling both outlets located on top of the housing, according to an embodiment of the technology; and

FIG. 9 is a top view schematic diagram of the switchable electrical power outlet adapter of FIG. 8.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a switchable electrical power outlet adapter to eliminate idle power drain, save energy consumers money, and do so in an environmentally supportive manner.

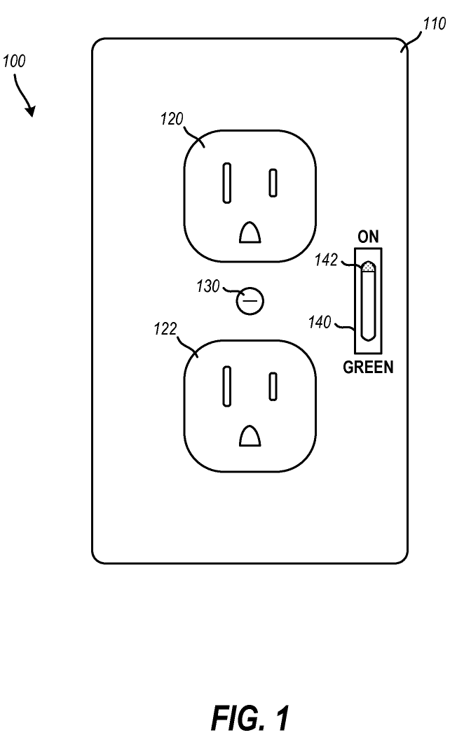

Referring now to FIG. 1, a front view diagram of a switchable electrical power outlet adapter 100 is shown. The switchable electrical power outlet adapter 100 is utilized between an electrical receptacle connected to a commercial power supply and an electric appliance in order to eliminate idle power drain. The switchable electrical power outlet adapter 100 includes a housing having a front cover 110 and mounting screw 130 within which various components of the adapter are located. The mounting screw 130 is utilized in various embodiments wherein the screw passes through the housing into the empty screw hole of the electrical receptacle and can securely hold the switchable electrical power outlet adapter 100 to the existing electrical receptacle such that it can not be pulled out inadvertently. However, the mounting screw 130 is not required to utilize the switchable electrical power outlet adapter 100 in an electrical receptacle. The switchable electrical power outlet adapter 100 includes receptacle sockets 120, 122 accessible through the housing cover 110. Plugs from electrical appliances, and the like, can be plugged into the receptacle sockets 120, 122 for connectivity to the commercial power supply or electrical utility.

The switchable electrical power outlet adapter 100 also includes a control circuit disposed within the housing. The control circuit is configured to selectively terminate electrical connectivity between the adapter 100 and the electrical appliance. The switchable electrical power outlet adapter 100 also includes a switch 140 disposed upon the housing and electrically connected to the control circuit. The switch has an ON state and an OFF state. The OFF state of the switch 140 is visually represented on the housing of the switchable electrical power outlet adapter as GREEN to encourage greater use of the switchable electrical power outlet adapter 100 and greater energy efficiency. Indicator 142 is shown when the switch 140 is in an OFF state, showing or illuminating a green color. As shown in FIG. 1, switch 140 controls both receptacle sockets 120, 122. As such, both receptacle sockets 120, 122 are switchable by single switch 140.

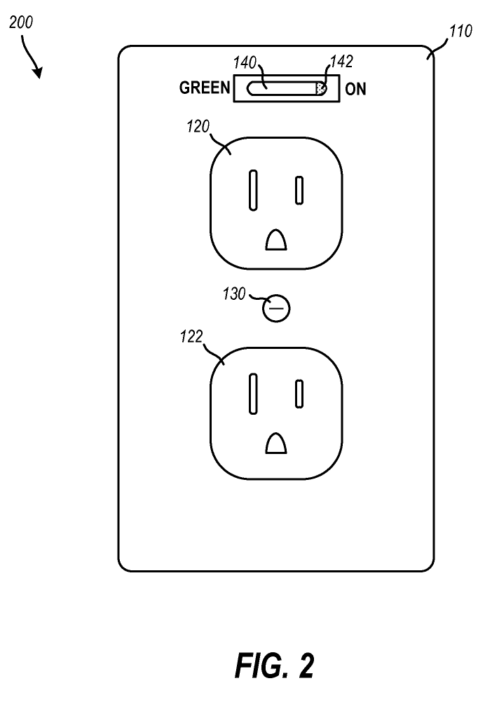

Referring now to FIG. 2, a front view diagram of another switchable electrical power outlet adapter 200 is shown. The switchable electrical power outlet adapter 200 is utilized between an electrical receptacle connected to a commercial power supply and an electric appliance in order to eliminate idle power drain. The switchable electrical power outlet adapter 100 includes a housing having a front cover 110 and mounting screw 130 within which various components of the adapter are located. The switchable electrical power outlet adapter 200 includes receptacle sockets 120, 122 accessible through the housing cover 110. Plugs from electrical appliances, and the like, can be plugged into the receptacle sockets 120, 122 for connectivity to the commercial power supply or electrical utility.

The switchable electrical power outlet adapter 200 also includes a control circuit disposed within the housing. The control circuit is configured to selectively terminate electrical connectivity between the adapter 200 and the electrical appliance. The switchable electrical power outlet adapter 200 also includes a switch 140 disposed upon the housing near receptacle 120 and electrically connected to the control circuit. The switch has an ON state and an OFF state. The OFF state of the switch 140 is visually represented on the housing of the switchable electrical power outlet adapter as GREEN to encourage greater use of the switchable electrical power outlet adapter 100 and greater energy efficiency. Indicator 142 is shown when the switch 140 is in an OFF state, showing or illuminating a green color. As shown in FIG. 2, switch 140 controls only receptacle sockets 120, the top receptacle. As such, receptacle socket 120 is switchable by single switch 140.

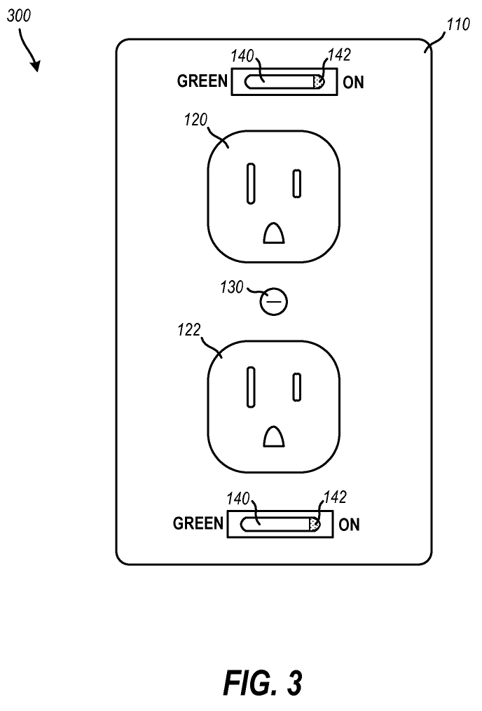

Referring now to FIG. 3 a front view diagram of yet another switchable electrical power outlet adapter 300 is shown. The switchable electrical power outlet adapter 300 is utilized between an electrical receptacle connected to a commercial power supply and an electric appliance in order to eliminate idle power drain. The switchable electrical power outlet adapter 100 includes a housing having a front cover 110 and mounting screw 130 within which various components of the adapter are located. The switchable electrical power outlet adapter 300 includes receptacle sockets 120, 122 accessible through the housing cover 110. Plugs from electrical appliances, and the like, can be plugged into the receptacle sockets 120, 122 for connectivity to the commercial power supply or electrical utility.

The switchable electrical power outlet adapter 300 also includes a control circuit disposed within the housing. The control circuit is configured to selectively terminate electrical connectivity between the adapter 300 and the electrical appliance. The switchable electrical power outlet adapter 300 also includes two switches 140 disposed upon the housing, one near receptacle 120 and one near receptacle 122, both electrically connected to the control circuit. The switch has an ON state and an OFF state. The OFF state of switches 140 is visually represented on the housing of the switchable electrical power outlet adapter as GREEN to encourage greater use of the switchable electrical power outlet adapter 100 and greater energy efficiency. Indicator 142 is shown when a switch 140 is in an OFF state, showing or illuminating a green color. As shown in FIG. 3, switches 140 control both receptacle sockets 120 and 122 independently of one another.

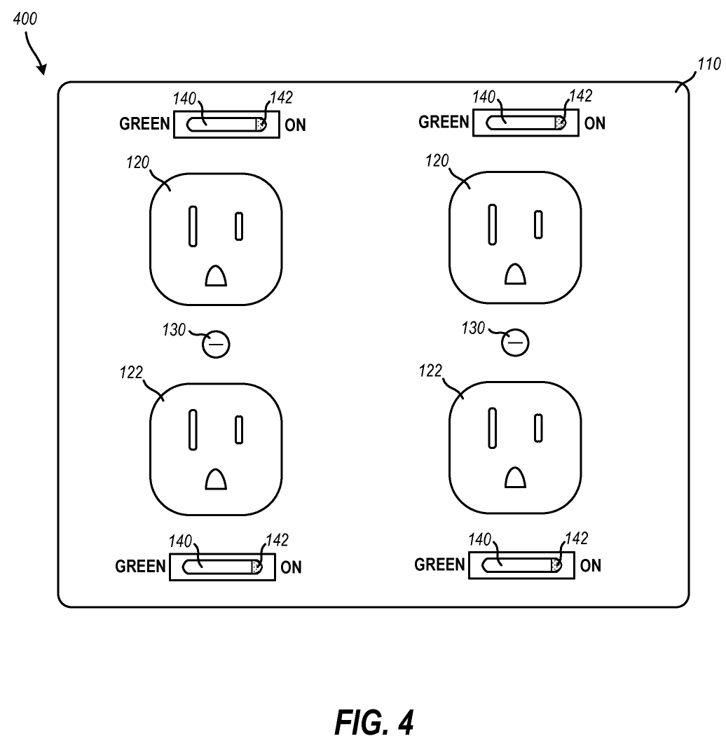

Referring now to FIG. 4, a front view diagram of yet another switchable electrical power outlet adapter 400 is shown. The switchable electrical power outlet adapter 400 of FIG. 4 includes all of the embodiments of the switchable electrical power outlet adapter 300 of FIG. 3. However, in addition, rather than being a duplex AC power socket, the switch shown here is a quad AC power socket. The receptacle sockets 120, 122 are controlled individually by switches 140. In this embodiment, any where between one and four of the electrical receptacles can operate in an OFF (GREEN) mode.

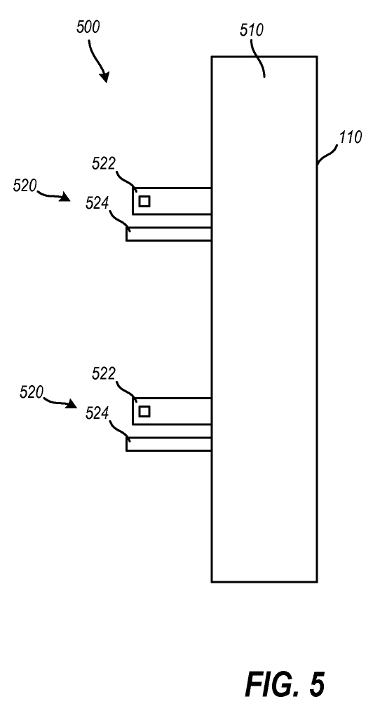

Referring now to FIG. 5, a side view diagram 500 of the switchable electrical power outlet adapter 100 of FIG. 1 is shown. The switchable electrical power outlet adapter 100 includes a housing 510 having a front cover 110 within which various components of the adapter are located. The switchable electrical power outlet adapter 100 includes at least one plug 520 disposed upon a rear of the housing 510. Each plug 520 is configured for insertion into an existing electrical receptacle in a wall, or the like. Each plug 520 includes hot 522, neutral (not shown, behind hot 522), and ground 524 leads to fit in standard electrical receptacles.

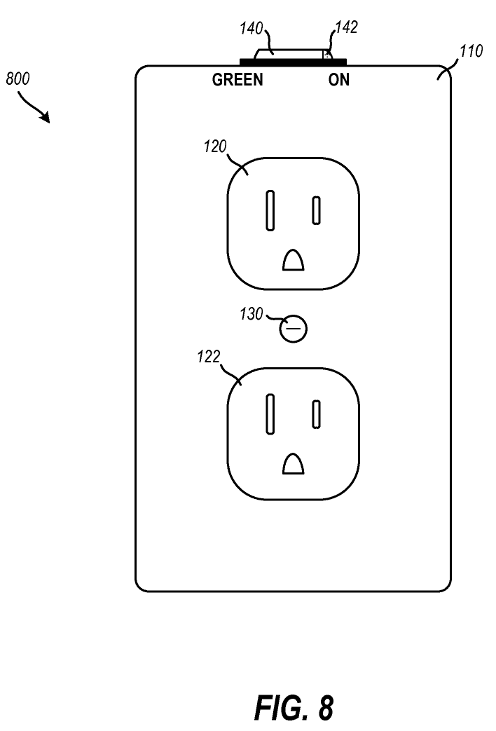

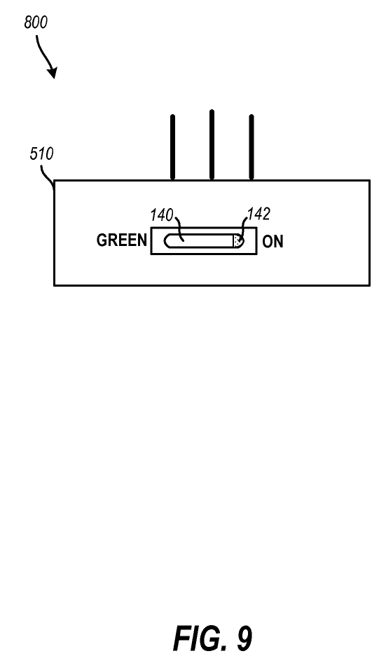

In alternative embodiments, the switchable electrical power outlet adapter includes various placement configurations of the switch, or switches, controlling power to each receptacle 120, 122. For example, FIG. 8 depicts an alternate configuration 800 in which a switch 140 is placed on top of the housing rather than on the front cover 110. In such a configuration, labeling or logos, for example, can be placed alongside the switch 140 on the top of the housing or on the front cover 110, as shown. FIG. 9 depicts a top view of the configuration 800 shown in FIG. 8 and illustrates the top of the housing 510. Any switch 140 can, for example, be located on the front cover 110 and on any side of the housing 510 including top, bottom, right, and left sides.

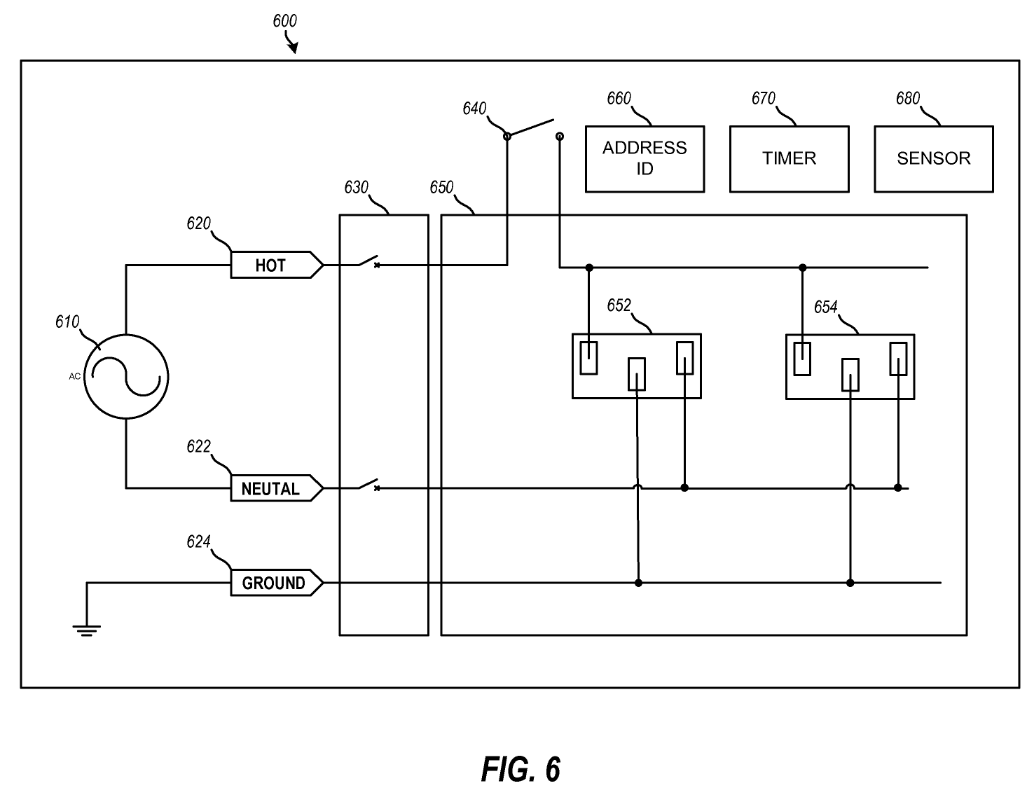

Referring now to FIG. 6, a schematic diagram 600 of the electrical control circuit for a switchable electrical power outlet adapter 100 of FIG. 1 is shown. The switchable electrical power outlet adapter 100 is configured for electrical connectivity to an alternating current (AC) source 610 with electrical connectivity with a commercial power supply. An AC source 610 is available in standard wall outlets. The AC source 610 includes hot 620, neutral 622, and ground 624 leads.

A circuit breaker box 630 is shown. The hot 620, neutral 622, and ground 624 leads have electrical connectivity through the circuit breaker box 630 for safety. The switchable electrical power outlet adapter 100 is represented schematically in box 650 in diagram 600. The switchable electrical power outlet adapter 100 also includes a switch 640, electrically connected to the hot lead 620, to selectively alternative the hot lead 620 between an ON state and an OFF state. Electrical receptacles 652, 654 are shown with electrical connectivity to the hot 620, neutral 622, and ground 624 leads.

The electrical control circuit for a switchable electrical power outlet adapter 100 includes an address ID 660. Each switchable electrical power outlet adapter 100 is uniquely identifiable. The address ID 660 is a uniquely identifiable address specific to the switchable electrical power outlet adapter 100. The switchable electrical power outlet adapter 100 is remotely accessible based on the unique adapter address ID 660. By way of example, the address ID 660 can be a media access control (MAC) address, internet protocol (IP) address, adapter address, physical address, or the like, so long as each switchable electrical power outlet adapter 100 is uniquely identifiable

The electrical control circuit 600 for a switchable electrical power outlet adapter 100 also includes a sensor 680. The sensor 680 is electrically connected to the control circuit 600 and is configured to detect power usage of the electrical appliance and to ascertain that the electrical appliance is operating in one of a stand-by mode and a full-power mode. The sensor 680 is remotely accessible, with the address ID 660, such that activity of the switchable electrical power outlet adapter 100 and attached electrical appliance is monitored remotely and wherein the control circuit 600 can be influenced remotely to transition a switchable electrical power outlet adapter 100 to an OFF state through switch 640.

The electrical control circuit 600 for a switchable electrical power outlet adapter 100 also includes a timer 670. The timer 670 is electrically connected to the control circuit 600 and is configured to measure a predetermined time an electrical appliance attached to the switchable electrical power outlet adapter 100 is operating in a stand-by mode at which point the switchable electrical power outlet adapter 100 will be turned to an OFF state through switch 640.

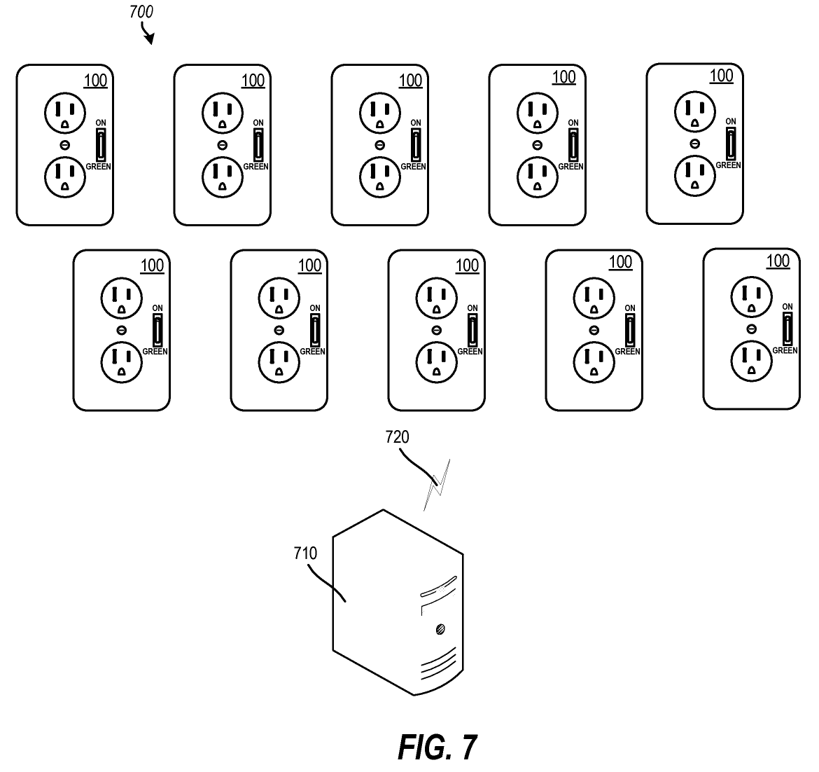

Referring now to FIG. 7, a schematic diagram 700 of a multiplicity of switchable electrical power outlet adapters 100 in a centralized remote monitor and control configuration is shown. Utilizing the sensors 680, timers 670, and address IDs 660 in each switchable electrical power outlet adapter 100 (as shown in FIG. 6), centralized mentoring and control is attained. Connectivity 720 to the multiplicity of switchable electrical power outlet adapters 100 from the central computer 710 can be wireless or tethered connectivity. Tethered connectivity can include utilization of the AC electrical wires as a data network.

Through a central computer 710, such as, but not limited to, a home or office systems control program or an off-site monitoring service analogous to a home-security monitoring service, power consumption and utilization is monitored to look for continued idle power drain at a particular switchable electrical power outlet adapter 100. When continued idle power drain is detected by a sensor 680, various actions can be taken. For example, the receptacle can be switched to an OFF (GREEN) state. Alternatively, a timer 670 can be activated to switch the receptacle to an OFF (GREEN) state after a predetermined amount of time has passed with idle power drain present.

In addition to the switchable electrical power outlet adapter 100, a switchable electrical power outlet is disclosed. Similar to the adapter, except without the plugs on the rear of the housing, the outlet includes an electrical receptacle housing; a receptacle socket disposed upon the electrical receptacle housing, the receptacle socket configured for receipt of a plug on an electric appliance; a control circuit disposed within the housing, the control circuit configured to selectively terminate electrical connectivity between the electrical receptacle and the electrical appliance; and a switch disposed upon the housing and electrically connected to the control circuit, the switch having an ON state and an OFF state. The switchable electrical power outlet provides electrical connectivity from a commercial power supply to the electric appliance only when the switch is in the ON state, thereby eliminating idle power drain when the switch is in the OFF state.

The switchable electrical power outlet includes: a sensor disposed within the electrical receptacle housing and electrically connected to the control circuit, the sensor configured to detect power usage of the electrical appliance and to ascertain that the electrical appliance is operating in one of a stand-by mode and a full-power mode.

The switchable electrical power outlet also includes: an adapter address, the adapter address being a uniquely identifiable address specific to the switchable electrical power outlet, wherein the switchable electrical power outlet is remotely accessible based on the unique adapter address.

The switchable electrical power outlet further includes: a timer disposed within the electrical receptacle housing and electrically connected to the control circuit, the timer configured to measure a predetermined time the electrical appliance is operating in a stand-by mode at which point the switchable electrical power outlet will be turned to an OFF state.

By way of example, the switchable electrical power outlet adapter 100 can eliminate idle power drain and conserve energy for the following electric appliances: phone chargers, electric tooth brushes, electric razors, countertop microwaves, bay monitors, coffee makers, blow dryers, curling irons, VCR/DVD players, laptop computers, radios, CD/DVD players, toaster ovens, food processors, mixers, blenders, electric grills, electric can openers, coffee grinders, space heaters, sewing machines, electric blankets, room humidifiers, televisions, cable boxes, espresso machines, irons, and the like.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A switchable electrical power outlet adapter for use between an electrical receptacle connected to a commercial power supply and an electric appliance in order to eliminate idle power drain, the adapter comprising:
a housing;
a plug disposed upon a rear of the housing, the plug configured for insertion into an electrical receptacle;
a receptacle socket disposed upon the housing, the receptacle socket configured for receipt of a plug on an electric appliance;
a control circuit disposed within the housing, the control circuit configured to selectively terminate electrical connectivity between the electrical receptacle and the electrical appliance; and
a switch disposed upon the housing and electrically connected to the control circuit, the switch having an ON state and an OFF state.

2. The switchable electrical power outlet adapter of claim 1, wherein the switchable electrical power outlet adapter provides electrical connectivity from a commercial power supply to the electrical receptacle, through the electrical power outlet adapter, and to the electric appliance only when the switch is in the ON state, thereby eliminating idle power drain when the switch is in the OFF state.

3. The switchable electrical power outlet adapter of claim 1, wherein the switchable electrical power outlet adapter provides for the convertibility of an existing electrical receptacle into a switchable power outlet.

4. The switchable electrical power outlet adapter of claim 1, wherein the receptacle socket comprises a duplex AC power socket.

5. The switchable electrical power outlet adapter of claim 1, wherein the receptacle socket comprises a quad AC power socket.

6. The switchable electrical power outlet adapter of claim 1, wherein the switch comprises a single pull single throw (SPST) switch.

7. The switchable electrical power outlet adapter of claim 1, further comprising:
a sensor disposed within the housing and electrically connected to the control circuit, the sensor configured to detect power usage of the electrical appliance and to ascertain that the electrical appliance is operating in one of a stand-by mode and a full-power mode.

8. The switchable electrical power outlet adapter of claim 7, wherein the sensor is remotely accessible such that activity of the switchable electrical power outlet adapter and attached electrical appliance is monitored remotely and wherein the control circuit can be influenced remotely to transition a switchable electrical power outlet adapter to an OFF state.

9. The switchable electrical power outlet adapter of claim 1, further comprising:
an adapter address, the adapter address being a uniquely identifiable address specific to the switchable electrical power outlet adapter, wherein the switchable electrical power outlet adapter is remotely accessible based on the unique adapter address.

10. The switchable electrical power outlet adapter of claim 1, further comprising:
a timer disposed within the housing and electrically connected to the control circuit, the timer configured to measure a predetermined time the electrical appliance is operating in a stand-by mode at which point the switchable electrical power outlet adapter will be turned to an OFF state.

11. The switchable electrical power outlet adapter of claim 1, wherein the OFF state of the switch is visually represented on the housing of the switchable electrical power outlet adapter as GREEN to encourage greater use of the switchable electrical power outlet adapter and greater energy efficiency.

12. A method for eliminating idle power drain between an electrical receptacle connected to a commercial power supply and an electric appliance, the method comprising:
utilizing a switchable electrical power outlet adapter comprising a housing; a plug disposed upon a rear of the housing; the plug configured for insertion into an electrical receptacle; a receptacle socket disposed upon the housing, the receptacle socket configured for receipt of a plug on an electric appliance; a control circuit disposed within the housing, the control circuit configured to selectively terminate electrical connectivity between the electrical receptacle and the electrical appliance; and a switch disposed upon the housing and electrically connected to the control circuit, the switch having an ON state and an OFF state;
plugging the switchable electrical power outlet adapter into the electrical receptacle;
plugging the electrical appliance into the receptacle socket disposed upon the housing of the switchable electrical power outlet adapter; and
selectively alternating the switch to an OFF state to eliminate idle power drain when the electrical appliance is not needed for use.

13. The method of claim 12, further comprising:
utilizing a switchable electrical power outlet adapter further comprising a sensor disposed within the housing and electrically connected to the control circuit, the sensor configured to detect power usage of the electrical appliance and to ascertain that the electrical appliance is operating in one of a stand-by mode and a full-power mode;
detecting the power usage of the electrical appliance;
ascertaining that the electrical appliance is operating in one of a stand-by mode and a full-power mode; and
alternating the switch to an OFF state when it is ascertained that the electrical appliance has been operating in a stand-by mode for more than a predetermined amount of time.

14. The method of claim 12, further comprising:
utilizing a switchable electrical power outlet adapter further comprising an adapter address, the adapter address being a uniquely identifiable address specific to the switchable electrical power outlet adapter, wherein the switchable electrical power outlet adapter is remotely accessible based on the unique adapter address; and
remotely accessing the switchable electrical power outlet adapter based upon the unique adapter address.

15. The method of claim 12, further comprising:
utilizing a switchable electrical power outlet adapter further comprising a timer disposed within the housing and electrically connected to the control circuit, the timer configured to measure a predetermined time the electrical appliance is operating in a stand-by mode at which point the switchable electrical power outlet adapter will be turned to an OFF state;
setting the predetermined time;
ascertaining the electrical appliance is operating in a stand-by mode for a time period greater than the predetermined time; and
alternating the switch to an OFF state to eliminate idle power drain.

16. A switchable electrical power outlet to eliminate idle power drain, the outlet comprising:
an electrical receptacle housing;
a receptacle socket disposed upon the electrical receptacle housing, the receptacle socket configured for receipt of a plug on an electric appliance;
a control circuit disposed within the housing, the control circuit configured to selectively terminate electrical connectivity between the electrical receptacle and the electrical appliance; and
a switch disposed upon the housing and electrically connected to the control circuit, the switch having an ON state and an OFF state.

17. The switchable electrical power outlet of claim 16, wherein the switchable electrical power outlet provides electrical connectivity from a commercial power supply to the electric appliance only when the switch is in the ON state, thereby eliminating idle power drain when the switch is in the OFF state.

18. The switchable electrical power outlet of claim 16, further comprising:
a sensor disposed within the electrical receptacle housing and electrically connected to the control circuit, the sensor configured to detect power usage of the electrical appliance and to ascertain that the electrical appliance is operating in one of a stand-by mode and a full-power mode.

19. The switchable electrical power outlet of claim 16, further comprising:
an adapter address, the adapter address being a uniquely identifiable address specific to the switchable electrical power outlet, wherein the switchable electrical power outlet is remotely accessible based on the unique adapter address.

20. The switchable electrical power outlet of claim 16, further comprising:
a timer disposed within the electrical receptacle housing and electrically connected to the control circuit, the timer configured to measure a predetermined time the electrical appliance is operating in a stand-by mode at which point the switchable electrical power outlet will be turned to an OFF state.
